(19) United States
(12) Patent Application Publication
(10) Pub. No.: US 2005/0175751 A1
(43) Pub. Date: Aug. 11, 2005

(54) Method of extracting isoflavon from soybeans

(76) Inventor: Cheng-Jen Lin, Yungho City (TW)

Correspondence Address: HERSHKOVITZ & ASSOCIATES, 1725 I STREET NW, SUITE 300, WASHINGTON, DC, 20006, US

(21) Appl. No.: 10/773,217

(22) Filed: Feb. 9, 2004

(51) Int. Cl. A23P 1/00

(52) U.S. Cl. 426/481

(57) ABSTRACT

A method of extracting isoflavon from soybeans or residuum of soybeans, the method includes: a pulverizing process, a fermenting process, a first filtering process, an extracting process, a second filtering process, and at least one drying process. By fermenting the soybeans, cell walls on seed coats of the soybeans are destroyed to release a high level of isoflavon in the extracting process to achieve a high production rate of isoflavon powder and to result in a low manufacturing cost. Moreover, fermented solid obtained from the second filtering process contains a high level of soybean enzyme that is suitable to be processed to generate high added-value feeding material.

### BACKGROUND OF THE INVENTION

1. Field of the Invention

The present invention relates to a method of extracting isoflavon from soybeans, and more particularly to a method that not only extracts isoflavon from the soybeans but also obtains high added-value byproducts of the soybeans.

2. Description of Related Art

In recent years, many nations have seen their traditional diets replaced by high fat, low fiber and calorie rich foods. Unavoidably, such kind of eating culture brings some syndromes such as corpulency, cancer, cardiovascular disease, diabetes, osteoporosis which results in very serious health threats and accordingly high medical costs to those nations. In order to cure the syndromes caused from the new eating culture without creating other side-effects, medicine scientists progressively research natural compounds from food to help people suffering with those syndromes. Isoflavon is one of the natural compounds obtained from soybeans.

Isoflavon has the same medicinal effect as estrogen that is used to ease discomfort experienced by menopausal women. However, using estrogen in high doses or over a long term causes some serious ailments such as breast cancer and cervical carcinoma etc. Isoflavon does not have the side-effects as estrogen when isoflavon is used to treat menopausal women. According to other medical reports, isoflavon not only reduces the occurring chances of breast cancer, cervical carcinoma, or oophoroma in women but also prevents prostate cancer and benign prostate hyperplasia (BPH) in men. Additionally, isoflavon also can promote absorption of calcium in bones to prevent osteoporosis.

Isoflavon is a broad name for a series of flavon compounds containing glycosylated groups and non-glycosylated groups and has a complex composition such that it is difficult to examine it using a standard pharmaceutical procedures and also difficult to be permitted by institutions of public health.

A conventional method to obtain isoflavon from soybeans is shown in FIG. 2. The method comprises acts of removing seed coats from the soybeans, removing oil, making soybean powder, dissolving the soybean powder in ethanol to remove protein, filtering the soybean powder, sopping the soybean powder into solutions, absorbing isoflavon, eluting isoflavon, heating to remove moisture from the eluted isoflavon, and granulating isoflavon products by spray drying.

The conventional method directly uses soybeans to elute isoflavon and has high cost. The seed coats of the soybeans are processed to become feeding stuff and have no extra added-values. Because the manufacturing cost of isoflavon is too high, isoflavon can not be used in common food to serve as additives.

### SUMMARY OF THE INVENTION

To overcome the shortcomings of the conventional method of obtaining isoflavon from soybeans, the present invention provides a novel method of extracting isoflavon to mitigate or obviate the problems associated with the conventional method.

The main objective of the invention is to provide a method of extracting isoflavon from soybeans that has low manufacturing costs and further generates high added-value byproducts at the same time.

Other objects, advantages and novel features of the invention will become more apparent from the following detailed description when taken in conjunction with the accompanying drawings.

### BRIEF DESCRIPTION OF THE DRAWINGS

FIG. 1 is a functional block diagram of a method of extracting isoflavon from soybeans in accordance with the present invention; and

FIG. 2 is a functional block diagram of a conventional of eluting isoflavon from soybeans in accordance with prior art.

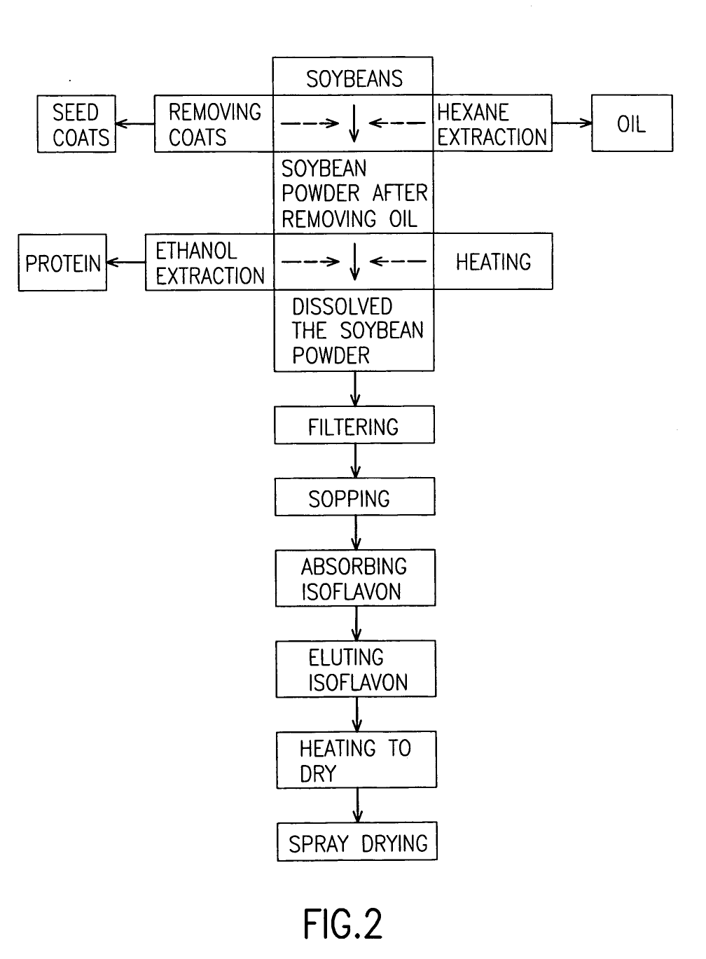

### DETAILED DESCRIPTION OF PREFERRED EMBODIMENT

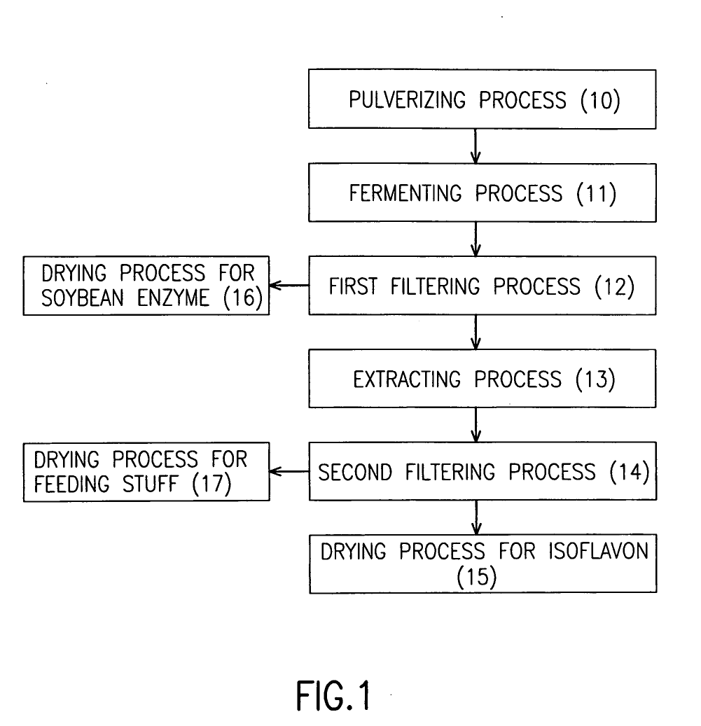

With reference to FIG. 1, a method of extracting isoflavon from soybeans in accordance with the present invention comprises the acts of: a pulverizing process, a fermenting process, a first filtering process, an extracting process, a second filtering process and a drying process.

In the pulverizing process (10), soybeans (or residuum of soybeans) are pulverized to become granules of sizes less than 2 mm diameter.

In the fermenting process (11), the granules are mixed with a microorganism such as Acetobacter aceti. to ferment for 7 to 14 days to generate fermented solid and fermented liquid containing soybean enzyme.

In the first filtering process (12), after the fermenting the granules are filtered by centrifuge to separate the fermented solid and fermented liquid.

In the extracting process (13), the fermented solid is pulverized again, sopped into an ethanol solution, and stirred at 45° C. to 48° C. for 24 hours to extract isoflavon from the fermented solid of the soybeans.

In the second filtering process (14), the ethanol solution containing isoflavon is separated from the fermented solid in the filtering process by means of centrifuge.

In the drying process for isoflavon (15), the separated ethanol solution is atomized and dried to become isoflavon powder by means of a spray drier.

Additionally, the method further comprises two drying processes. One drying process is for soybean enzyme (16), wherein the fermented liquid obtained from the first filtering process (12) contains high levels of soybean enzyme and is dried to become enzyme powder that is a high added-value byproduct. Another drying process is for feeding stuff (17), wherein the fermented solid left from the second filtering process (14) is further mixed with nutrients to compose feeding stuff.

The characteristic of the method in accordance with the present invention is that the soybeans are fermented before extraction. Although the seed coats of the soybeans contains high levels of isoflavon it is hard to be decomposed then to release the isoflavon. Using acetobacter aceti. in the fermenting process destroys the cell walls of the seed coats to release the isoflavon enclosed in the cell walls. Therefore, more isoflavon can be released into the ethanol solution and obtained to generate more isoflavon products. The extraction rate of the isoflavon in the present method is 60 to 70% based on the total amount of isoflavon in the soybeans, which is significantly higher than an extraction rate of 25 to 30% in the conventional method. Thus, the manufacturing cost of isoflavon is reduced and isoflavon can be commonly used as food additives or further purified to achieve condensed medicine.

Additionally, the method can use waste residuum of soybeans as well as complete soybeans to obtain isoflavon so that material cost in this method is low. The fermented liquid obtained from the first filtering process (12) contains soybean enzyme that is a high added-value byproduct in this method. Moreover, the fermented solid obtained from the second filtering process (12) still can be mixed with other nutrients to serve as feeding stuff.

Although the invention has been explained in relation to its preferred embodiment, many other possible modifications and variations can be made.

1. A method of extracting isoflavon from soybeans, comprising:
a pulverizing process, wherein soybeans are pulverized to become granules;
a fermenting process, wherein the granules are mixed with at least one microorganism to ferment to achieve fermented solid and fermented liquid containing soybean enzyme;
a first filtering process, wherein the granules after fermenting are filtered to separate the fermented solid and the ferment liquid;
an extracting process, wherein the fermented solid is pulverized and sopped into an ethanol solution to extract isoflavon from the fermented solid;
a second filtering process, wherein the ethanol solution containing isoflavon is separated from the fermented solid; and
a drying process for the ethanol solution containing isoflavon, wherein the ethanol solution is atomized and dried to become isoflavon powder.

2. The method as claimed in claim 1, wherein the method further comprising a drying process for fermented liquid obtained from the first filtering process, in which the fermented liquid is dried to obtain powder of the soybean enzyme.

3. The method as claimed in claim 2, wherein the method further comprising a drying process for the fermented solid obtained from the second filtering process, in which the fermented solid is dried and added with nutrients to achieve feeding stuff.

4. The method as claimed in claim 1, wherein the granules in the pulverizing process have a diameter of less than 2 mm.

5. The method as claimed in claim 1, wherein in the fermenting process, the granules are mixed with the microorganism and fermented for 7 to 14 days.

6. The method as claimed in claim 1, wherein in the extracting process, the fermented solid and the ethanol solution are stirred for 24 hours at 45 to 48° C.

7. A method of extracting isoflavon from soybeans, comprising:
a pulverizing process, wherein soybeans are pulverized to become granules of sizes less than 2 mm diameter;
a fermenting process, wherein the granules are mixed with microorganism to ferment for 7 to 14 days to obtain fermented solid and fermented liquid containing soybean enzyme;
a first filtering process, wherein the granules after fermenting are filtered to separate the fermented solid and the fermented liquid;
an extracting process, wherein the fermented solid is pulverized, sopped into an ethanol solution, and stirred at 45° C. to 48° C. for 24 hours to extract isoflavon from the fermented solid of soybeans;
a second filtering process, wherein the ethanol solution containing isoflavon is separated from the fermented solid by means of a centrifuge;
a drying process for the ethanol solution containing isoflavon, wherein the ethanol solution is atomized and dried to generate isoflavon powder;
a drying process for fermented liquid obtained from the first filtering process, wherein the fermented liquid is dried to obtain powder of the soybean enzyme; and
a drying process for the fermented solid obtained from the second filtering process, wherein the fermented solid is dried and added with nutrients to achieve feeding stuff.

8. A method of extracting isoflavon from soybeans, comprising:
a pulverizing process, wherein residuum of soybeans is pulverized to become granules of sizes less than 2 mm diameter;
a fermenting process, wherein the granules are mixed with microorganism to ferment for 7 to 14 days to obtain fermented solid and fermented liquid containing soybean enzyme;
a first filtering process, wherein the granules after fermenting are filtered to separate the fermented solid and the fermented liquid;
an extracting process, wherein the fermented solid is pulverized, sopped into an ethanol solution, and stirred at 45° C. to 48° C. for 24 hours to extract isoflavon from the fermented solid of soybeans;
a second filtering process, wherein the ethanol solution containing isoflavon is separated from the fermented solid by means of a centrifuge;
a drying process for the ethanol solution containing isoflavon, wherein the ethanol solution is atomized and dried to generate isoflavon powder;
a drying process for fermented liquid obtained from the first filtering process, wherein the fermented liquid is dried to obtain powder of the soybean enzyme; and
a drying process for the fermented solid obtained from the second filtering process, wherein the fermented solid is dried and added with nutrients to achieve feeding stuff.

9. The method as claimed in claim 7, wherein the microorganism is Acetobacter aceti.

10. The method as claimed in claim 8, wherein the microorganism is Acetobacter aceti.
